(19) United States
(12) Patent Application Publication
(10) Pub. No.: US 2025/0196707 A1
(43) Pub. Date: Jun. 19, 2025

(54) PORTABLE ENABLER FOR EV BATTERY

(71) Applicant: Smartville, Inc., Carlsbad, CA (US)

(72) Inventors: William von Novak, San Diego, CA (US); Mohamed Afify, Oceanside, CA (US)

(21) Appl. No.: 18/975,819

(22) Filed: Dec. 10, 2024

Related U.S. Application Data
(60) Provisional application No. 63/610,837, filed on Dec. 15, 2023.

(51) Int. Cl. B60L 58/10; H01M 10/42; H01M 10/48

(52) U.S. Cl. CPC B60L 58/10; H01M 10/425; H01M 10/48; H01M 2010/4271; H01M 2010/4278; H01M 2220/20

(57) ABSTRACT

Systems, methods, and devices are provided for a enabling an EV battery. The enabler device may comprise a controller in electrical connection with the EV battery. The enabler device may further comprise a discrete signal interface for sending a discrete signal to the EV battery. The enabler device may further comprise a communication interface for sending a communication signal from the controller to the EV battery. The enabler device may further comprise a power interface electrically connected to the controller and configured to provide a power supply to the EV battery.

### CROSS-REFERENCE TO RELATED APPLICATIONS

This application claims priority to, and the benefit of, U.S. Provisional Patent Application No. 63/610,837, filed Dec. 15, 2023 and entitled “PORTABLE ENABLER FOR EV BATTERY,” which is hereby incorporated by reference herein.

### FIELD OF INVENTION

The present disclosure relates generally to a battery enabler, and, in particular, to a portable battery enabler which monitors and controls an EV battery.

### BACKGROUND

Electric vehicle (“EV”) batteries typically have various levels of electrical safety devices built. These electrical safety devices include contactors that disconnect power when the EV battery is off to safeguard against electrocution, various fuses to protect from damage caused by overcurrent, and battery management systems (“BMS”) that monitor the EV battery and turn off the EV battery when not in operation. These systems serve to contribute to safety of EV batteries. However, in some situations these systems make it difficult to test and monitor the EV batteries and can actually reduce safety during these situations.

For example, where an EV battery is disconnected from a load, the EV battery connectors are open and no voltage is present at the battery terminals, and a technician cannot safely check the open circuit voltage of this disconnected EV battery. As another similar example, if a user wants to use an EV battery in a simple power system the user would not have a safe and efficient way to enable to the battery so it can operate with the system.

Thus, there is a need for a safe way to enable an EV battery to allow testing, evaluation and use of a battery pack after it is disconnected from the EV, and before it is connected to a large scale battery storage system.

### SUMMARY

In an example embodiment, a method of enabling an EV battery is disclosed. The method may include providing, by a controller, a power supply to the EV battery. The method may further include transmitting, by the controller, a communication discrete signal to the EV battery. The method may further include receiving, by the controller, a signal from the EV battery in response to the providing a power supply. The method may further include transmitting, by the controller, the communication signal to the EV battery.

In another example embodiment, a battery enabler device for enabling an EV battery is disclosed. The device may comprise a controller in electrical connection with the EV battery. The device may further comprise a discrete signal interface for sending a discrete signal to the EV battery. The device may further comprise a communication interface for sending a communication signal from the controller to the EV battery. The device may further comprise a power interface electrically connected to the controller and configured to provide a power supply to the EV battery.

In another example embodiment, a method of enabling an EV battery is disclosed. The method may include providing, by a controller, a power supply to the EV battery. The method may further include transmitting, by the controller, a first discrete signal and a second discrete signal to the EV battery. The method may further include receiving, by the controller, a signal from the EV battery in response to the providing the first discrete signal and the second discrete signal.

### BRIEF DESCRIPTION OF THE DRAWING FIGURES

Additional aspects of the present disclosure will become evident upon reviewing the non-limiting embodiments described in the specification and the claims taken in conjunction with the accompanying figures, wherein like numerals designate like elements, and:

FIG. 1 is a diagram illustrating an example battery enabler system, in accordance with various embodiments;

FIG. 2 is an enabler device, in accordance with various embodiments;

FIG. 3 is a battery enabler cable system, in accordance with various embodiments; and

FIG. 4 is a flow diagram illustrating an example method, in accordance with various embodiments.

### DETAILED DESCRIPTION

Reference will now be made to the exemplary embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

In accordance with an example embodiment, systems, devices and methods are provided for enabling an EV battery. In an example embodiment, the EV battery is disconnected from the electric vehicle. In an example embodiment, an enabler is attached to an EV battery. Although described herein as an EV battery, in various example embodiments the battery may have been used in any suitable application. In its disconnected state, the EV battery may be disabled. Disabled may mean that the EV battery may have its BMS system turned off, contactors for the main power connectors open, and/or the like.

In an example embodiment, the enabler may provide signals and/or power to the EV battery to enable the EV battery. For example, the enabler may provide discrete signals and/or communications to the EV battery, such as a +12V power supply, control signals, and/other communications. In various embodiments, the battery enabler system may comprise a switch to connect the output terminals of the EV battery. In various embodiments, the battery enabler system may further comprise an enabler battery or power supply. The enabler battery or power supply may be used to power the components of the enabler and/or provide power to the EV battery. In various embodiments, the enabler battery may also receive power from the EV battery.

In an example embodiment, the enabler may comprise a controller. The controller may be connected to the EV battery data ports, to facilitate the controller receiving information from the EV battery and/or to sending information to the EV battery. Among other information, the controller may communicate with the BMS of the EV battery. The controller may receive battery state of health information from the BMS of the EV battery. The controller further may have information useful to those shipping the battery, and in particular to battery safety information. The enabler may be used by factory workers, battery recycling facilities, EV battery re-purposers and others wanting to safely test an EV battery outside of an EV. The enabler may allow the main power output to actively output power temporarily to ensure safety. For example, the enabler may allow the main power output to be enabled to test the various components of the EV battery, such that there is only a temporary power output so the contactors, BMS and fuses can be verified. These and other advantages are described in more detail below.

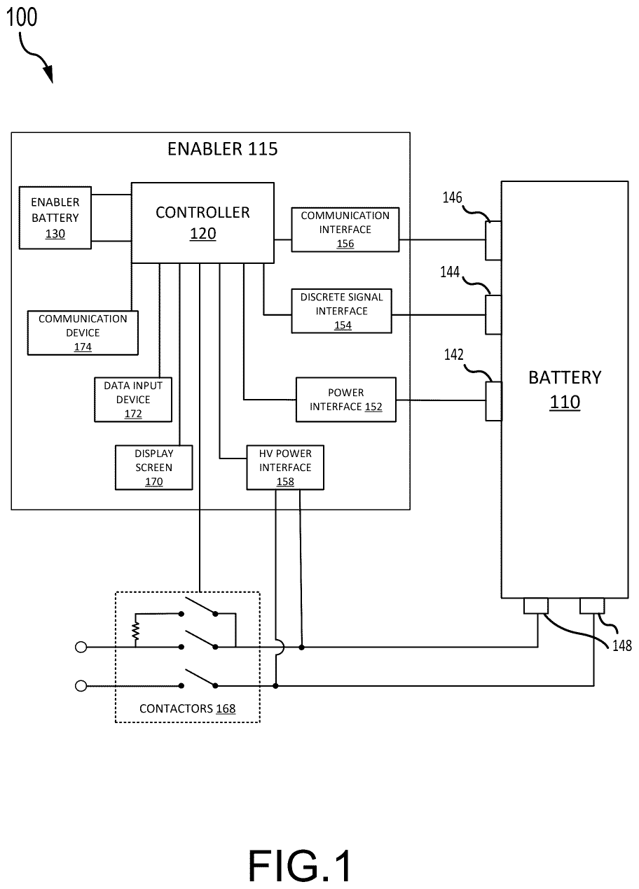

With reference now to FIG. 1, a battery enabler system 100 is illustrated. The battery enabler system 100 may comprise battery 110 and enabler 115. In an example embodiment, the battery 110 may comprise a power connector 142, and a signal connector 144, and/or a communication port 146. In various embodiments, the battery 110 may comprise main power output 148. In various embodiments, one or more of the power connector 142, the signal connector 144, and/or the communication port 146 may be combined to a single port on the battery 110.

In various embodiments, the battery 110 may be an EV battery. In various embodiments the battery 110 may comprise lithium ion phosphate (LFP) cells. In other example embodiments, the battery 110 may comprise a lithium ion battery. In various embodiments, the battery 110 may be an EV battery or any suitable battery comprising a signal connector 144. In various embodiments, the battery 110 may be in communication with the enabler 115 by one or more of the power connector 142, the signal connector 144, and the communication port 146. In various embodiments, the enabler 115 may be connected to the main power output 148 of the battery 110.

In various embodiments, the enabler 115 may comprise a controller 120. The controller 120 may be an embedded controller. The enabler 115 may be portable for easy transport and connection to the battery 110. In various embodiments, the enabler 115 may comprise a communication interface 156, discrete signal interface 154, a power interface 152 each for sending and/or receiving signals or power to the battery 110. In various embodiments, the controller 120 may be configured to control the various components of the enabler 115 as described in more detail herein.

In various embodiments, the enabler 115 may be connected to the battery 110 by a communication interface 156. The communication interface 156 may be used to transfer signals including communication signals between the controller 120 and the battery 110. The communication interface 156 may be electrically connected to the battery 110 by the communication port 146. In various embodiments, the communication port 146 may be a data input or output device. In various embodiments, the communication port 146 may be a Controller Area Network (“CAN”) data bus or other suitable data communication port 146. In various embodiments, the communication interface 156 may be used to send and receive signals from the battery 110. In various embodiments, the communication interface 156 may be configured to provide a CAN interface, an RS485 interface, or any other interface suitable for the battery 110. In various embodiments, the enabler 115 may send communications or power to the battery 110 to enable the battery 110 to provide signals from the communication port 146. For example, the enabler 115 may provide power and signals to the battery 110 and in response the battery 110 may provide signals from the communication port 146 to the communication interface 156 of the enabler.

In various embodiments, the enabler 115 may support communications protocols such as CAN ISO 11898-1, High & Low speed CAN ISO 11898-2 ISO 11898-3. OBD Protocols such as ISO 9141-2, ISO 14230-4, SAE J1850, ISO 15765-4 and SAE J1939. In various embodiments, the enabler 115 may be connected to the battery 110 by any suitable connection, including directly to the charge port (CHAdeMO, CSS1, SCC2, etc.), OBDII Bluetooth connection, or other data information ports of a battery as discussed herein, such as a shared CAN bus.

In various embodiments, the enabler 115 may comprise a discrete signal interface 154. The discrete signal interface 154 may be configured to provide discrete signals (i.e. contactor or BMS power) to the battery 110. The discrete signal interface 154 may be connected to the signal connector 144 of the battery 110 or other connector on the battery 110 capable of receiving discrete signals. In various embodiments, the discrete signal interface 154 of the enabler 115 may provide contactor power to the battery 110 to enable the battery 110 and/or energize the battery 110. In various embodiments, the discrete signal interface 154 may send one or more discrete signals to the battery 110. For example, the discrete signal interface 154 may send a first discrete signal to the battery 110 to activate the BMS, and a second discrete signal to activate the main power output 148. In various embodiments, the discrete signal interface 154 may further send additional discrete signals to the battery 110 to enable the battery 110. In various embodiments, the discrete signals sent by the controller 120 to the battery 110 may comprise a signal from an external temperature sensor, or a high voltage interlock signal, or a specific impedance that the main power output 148 needs to receive for the battery 110 to power on.

In various embodiments, the enabler 115 may comprise a power interface 152. The power interface 152 may be configured to provide power to the battery 110. In various embodiments, the power interface 152 may be connected to the power connector 142 of the battery 110. In various embodiments, the enabler 115 may provide power to the battery 110 in the form of 12V DC or other voltage suitable to enable the battery 110. In various embodiments, the controller 120 may send power to the BMS interface of the battery 110 and/or contactors of the battery 110. In various embodiments, the controller 120 may send power directly to the contactors of the battery 110.

In various embodiments, the enabler 115 may enable various EV batteries by sending one or more discrete signals and/or power to the EV battery. In various embodiments, the discrete signal may be a power supply, such as a +12V signal. For example, a Tesla battery may require two discrete signals to enable the Tesla battery. In various embodiments, the controller 120 may send two discrete signals to the battery 110. The controller 120 may send a first discrete signal to the discrete signal interface 154 of the battery 110 to power the BMS of the battery 110 and a second discrete signal to the discrete signal interface 154 to power the various internal contactors of the battery 110, and in response the battery 110 may become enabled. After the battery 110 is enabled, the controller 120 may send a CAN bus signal to the communication port 146 of the battery 110 and in response the battery 110 may output power from the main power output 148. In another example, a Nissan Leaf battery may require four discrete signals to enable the Leaf battery. In various embodiments, the controller 120 may send four discrete signals to the battery 110 to enable the battery 110. The controller 120 may send a first discrete signal, a second discrete signal, a third discrete signal and a fourth discrete signal to the discrete signal interface 154 of the battery 110. The first discrete signal may provide power to the BMS of the battery 110, the second discrete signal may energize the internal negative-terminal contactor of the battery 110, the third discrete signal may energize the internal precharge relay of the battery 110 and the fourth may energize the internal positive-terminal contactor of the battery 110.

In various embodiments, the power interface 152 may receive power from the battery 110. In various embodiments, the enabler 115 may receive power from the power connector 142 to power the enabler 115. In various embodiments, the power interface 152 may be configured to receive or provide power in the form of 12V or other suitable voltage.

In various embodiments, the enabler 115 may comprise an enabler battery 130. In various embodiments, the enabler battery 130 may be configured to receive power from an external power source (not shown). In various embodiments, the enabler battery 130 may be a re-chargeable battery.

In various embodiments, the enabler battery 130 may receive power from the battery 110. The enabler battery 130 may receive power from the controller 120 which was received from the battery 110.

In various embodiments, the controller 120 may be connected to an external power source (not shown). The external power source may be used to provide power to the enabler 115. The external power source may be connected to the enabler battery 130 and may provide power to the enabler battery 130. In various embodiments, the enabler 115 uses the external power source to provide power to the battery 110. In various embodiments, the enabler 115 may not include an enabler battery 130 and instead the external power source may connect directly to the controller 120.

In various embodiments, the enabler 115 may be configured to enable the battery 110. For example, the enabler 115 may be connected to an EV battery, such as a Tesla battery or Nissan leaf battery and send power or other signals to the battery 110 to enable the battery 110. Once the battery 110 is enabled, the battery 110 may provide a power output from the power connector 142 of the battery 110. The controller 120 may receive the power from the power connector 142 by the power interface 152.

In various embodiments, the enabler 115 may further comprise a display screen 170. The display screen 170 may be a digital display screen. The controller 120 may control the data displayed on the display screen 170. In various embodiments, the display screen 170 may show information sent or received by the enabler 115 to the battery 110. The display screen 170 may display the status of the battery 110. For example, the display screen 170 may display the BMS data of the battery 110. For example, the display screen 170 may display BMS data in a format that a technician can use to decide the health or safety of a battery. The display screen 170 may display data or other information sent or received by the enabler 115.

In various embodiments, the enabler 115 may further comprise a data input device 172. In various embodiments, the data input device 172 may be a keyboard, buttons, switches, or other device capable of selecting and/or entering data into the enabler 115. The data input device 172 may be in communication with the controller 120. A user may enter information or selections into the data input device 172. The controller 120 may then send or receive power or other communications with the battery 110 in response to the inputs to the data input device 172. The data input device 172 may be configured to receive an input to enable or disable the battery 110, to turn on/off the enabler 115, and/or to select data to be displayed on the display screen 170.

In various embodiments, the battery 110 may comprise a main power output 148. The main power output 148 may output a high current, high voltage power, ordinarily suitable for driving the traction motors of an EV. In various embodiments, the main power output 148 may be the main power output of the battery 110 used for powering EVs. In various embodiments, the main power output 148 may be connected to the enabler 115. In various embodiments, the enabler 115 may further comprise an impedance network (not shown). The impedance network may be connected to the main power output 148 of the battery 110 and be used to filter the power or provide a specific impedance to the output. The network may comprise capacitors (C) and/or resistors (R) connected to the main power output 148 to filter the power from the battery 110, and provide the correct impedance as seen from the main power output 148. For example, the network may comprise C or RC network connected to the main power output 148, wherein the output from the network may be connected to the enabler 115 or a test port. In various embodiments, the power from the main power output 148 may be connected to a meter for testing the power output. In various embodiments, the enabler 115 may further comprise a meter (not shown) for testing power output.

In various embodiments, the enabler 115 may further and additionally comprise a high voltage (HV) power interface 158. The HV power interface 158 may be connected to the main power output 148 of the battery 110. In various embodiments, the HV power interface 158 may receive high voltage power from the battery 110 and use the power received to power the enabler 115 and recharge the enabler battery 130. In various embodiments, the HV power interface 158 may be a power converter. For example, the HV power interface 158 may convert the power from the 400V DC received from the battery 110 to a usable 12V DC, or a usable 13.8V DC suitable for charging enabler battery 130.

In various embodiments, the enabler 115 may further include contactors 168. The contactors 168 may be used to isolate the battery 110 from the output. For example, the contactors 168 may be used between the controller 120 and the battery 110 to drive the load of the battery 110 to isolate the battery 110. In various embodiments, the contactors 168 may comprise two high power contactors to allow power flow from the battery 110. In various embodiments, the contactors 168 may comprise a precharge relay to charge up any capacitance that may be placed on the output of the enabler 115. For example, the contactors 168, including the precharge relay may allow the battery 110 to output to an external meter or other external load (not shown). The contactors 168 may allow the battery 110 to be isolated so the enabler 115 may present a desired impedance to the battery 110 even if an external device is connected. In various embodiments, the contactors 168 may be external to the enabler 115. In various embodiments, the contactors 168 may be in communication with the controller 120 of the enabler 115.

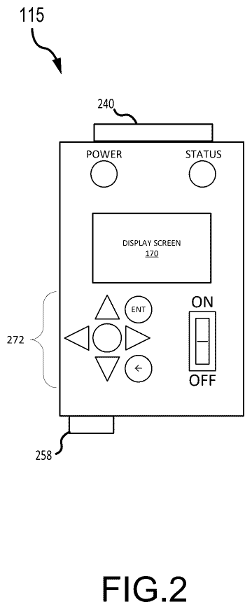

With reference now to FIG. 2, a housing for an enabler 115 is shown in accordance with various embodiments. The enabler 115 may be similar in design to that of FIG. 1. The enabler 115 may comprise a connector 240. The connector 240 may include the connectors described in reference to FIG. 1. For example, connector 240 may include connectors to connect enabler 115 to a power connector 142, and a signal connector 144, and/or a communication port 146. The enabler 115 may include a power button to turn on the enabler 115. The enabler 115 may include buttons or switches to turn the enabler 115 from the ON position to the OFF position, in order to enable battery 110. The enabler 115 may include input devices 272, similar to data input device 172 for selecting and inputting data in the enabler 115. In various embodiments, the enabler 115 may include power connector 258. In various embodiments, power connector 258 may connect the enabler 115 to a power source (not shown). The power source may be used to power the enabler 115 and enable battery 110, as described with reference to FIG. 1. The enabler 115 may be housed in a case rugged enough to survive the rigors of use in an outdoor automotive dismantling environment.

In various embodiments, the enabler 115 may further comprise a communication device 174. The communication device 174 may be in communication with the controller 120. The communication device 174 may be a wireless communication device. For example, the communication device 174 may comprise a WWAN transmitter (e.g. cellular 4G or 5G communications link, or a satellite communications link) or a WLAN transmitter (e.g. Bluetooth, 802.11 or Zigbee). In various embodiments, the communication device 174 may transmit data to another device or an external network. For example, a user may use a smart phone to send data to and receive data from the enabler 115. Additionally, in various embodiments, an external user may remotely monitor the enabler 115 via the communication device 174. The controller 120 may be in communication with the communication device 174 and store data associated with the communication device. For example, the controller 120 may intermittently store information of the battery 110 location based on location data from the communication device 150. Thus, the controller 120 may be configured to store historical location information for the battery 110.

In various embodiments, the communication device 174 may connect to the cloud and utilize previously stored information on that model and/or revision of battery to perform predictive analysis on the future health and/or lifetime of the battery. For example, the controller 120 may receive battery information from the battery 110 and provide battery information to a database through the communication device 174. The communication device 174 may receive information from the database in response to the battery information provided. For example, the controller 120 may determine the EV battery 110 is a Tesla Model 3 with various measured parameters, including number of times charged, charge percent, etc. The controller 120 may provide this battery information, including the battery history and battery status to the database, and in response the database may update predictive battery health models. The predictive battery health model may be passed on a plurality of battery history and battery status information.

In various embodiments, the enabler 115 may receive information from the battery 110 via the communication port 146. For example, the controller 120 may receive data and/or signals representative of the current and voltage of the battery 110. The controller 120 may monitor to determine if the temperature is too great, which may indicate thermal runaway. In various embodiments, the controller 120 may monitor the cell voltages of the battery 110 and determine whether the cell voltages are below or above a certain threshold. Additionally, in various embodiments, the controller 120 may determine whether the cell voltage of one cell of the battery 110 is decreasing or dropping much more rapidly than other cell voltages of the battery 110, which would indicate damage or degradation of that cell. In various embodiments, the controller 120 may measure temperature of the battery 110 and/or enabler battery 130, to ensure that the battery is not starting to overheat. Further, in various embodiments, the controller 120 may store temperature, voltage, and current histories, to ensure that the battery has not been mistreated prior to, or during, shipping.

In various embodiments, the controller 120 may receive health/tracking information from the battery 110 via the communication port 146. For example, the controller 120 may receive health tracking, history reports and/or safety indications from the battery 110. Further, the controller 120 may obtain additional information such as the temperature of battery 110, and unique identifiers of the battery 110. The controller 120 may be in communication with smoke, heat and flame detectors that may detect problems at the battery (not shown).

In various embodiments, the controller 120 may receive software and data updates over the data interface 174 to allow for field upgrades and patches.

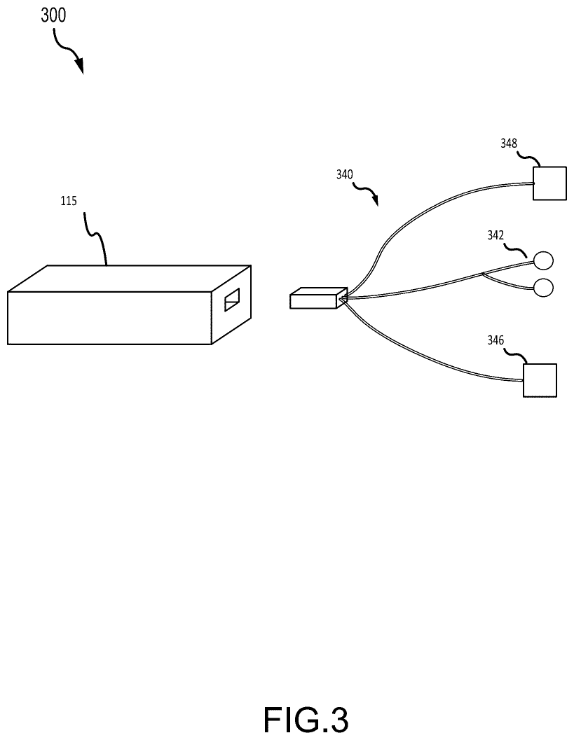

With reference now to FIG. 3, an enabler cable system 300 is shown in accordance with various embodiments. The enabler cable system 300 includes a cable plug 340 for connecting to the battery 110. In various embodiments, the cable plug 340 may comprise a main power connector 348 for connecting with the main power output 148 of the battery. In various embodiments, the cable plug 340 may include communication connector 346 for connecting to the communication port 146 of the battery 110. In various embodiments, the cable plug 340 may further include a power supply terminal 342 for connecting to the power connector 142 of the battery 110. The cable plug 340 may be removably attached to the enabler 115. In various embodiments, the cable plug 340 may be connected to the enabler 115 by a single port on the enabler 115.

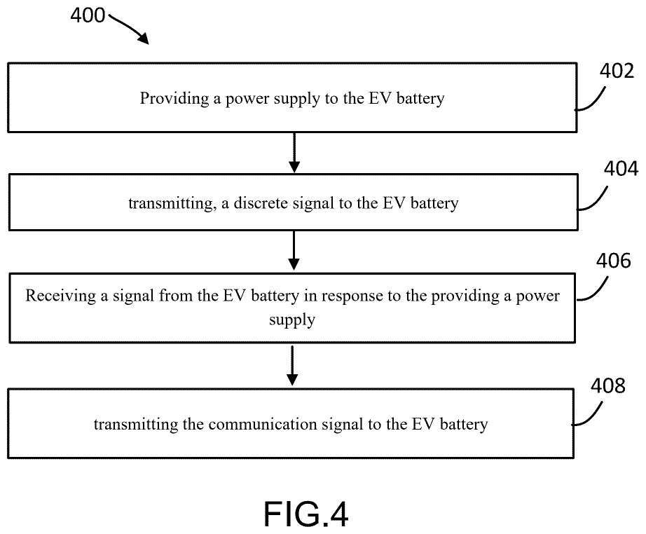

With reference now to FIG. 4, in accordance with an example embodiment, a method 400 of enabling an EV battery is disclosed. In various embodiments, method 400 may include providing, by a controller, a power supply to the EV battery (step 402). In various embodiments, method 400 may further comprise transmitting, by the controller, a discrete signal to the EV battery (step 404). In various embodiments, method 400 may further comprise receiving, by the controller, a signal from the EV battery in response to the providing a power supply (step 406). In various embodiments, method 400 may further comprise transmitting, by the controller, the communication signal to the EV battery (step 408).

Example embodiments of the systems, methods, and devices described herein may be implemented in hardware, software, firmware, or some combination of hardware, software, and firmware. For example, the block and schematic diagrams of FIGS. 1-4 may be implemented in hardware, software, firmware, or some combination of hardware, software, and firmware.

In the present disclosure, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in the numerical range are individual values such as 2, 3 and 4 and sub-ranges such as 1-3, 2-4 and 3-5, etc. The same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a defacto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives and is not intended to limit the selection to only those listed alternatives or to only one of the listed alternatives at a time, unless the context clearly indicates otherwise.

It should be appreciated that the particular implementations shown and described herein are illustrative of the example embodiments and their best mode and are not intended to otherwise limit the scope of the present disclosure in any way. Furthermore, the connecting lines shown in the various figures contained herein are intended to represent exemplary functional relationships and/or physical couplings between the various elements. It should be noted that many alternative or additional functional relationships or physical connections may be present in a practical device.

As one skilled in the art will appreciate, the mechanism of the present disclosure may be suitably configured in any of several ways. It should be understood that the mechanism described herein with reference to the figures is but one exemplary embodiment of the disclosure and is not intended to limit the scope of the disclosure as described above.

It should be understood, however, that the detailed description and specific examples, while indicating exemplary embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

What is claimed:

1. A method of enabling an EV battery comprising:
providing, by a controller, a power supply to the EV battery;
transmitting, by the controller, a discrete signal to the EV battery;
receiving, by the controller, a signal from the EV battery in response to the providing a power supply; and
transmitting, by the controller, the communication signal to the EV battery.

2. The method of claim 1, further comprising:
receiving, by the controller, data from the EV battery.

3. The method of claim 1, further comprising:
determining, by the controller, a power output of the EV battery.

4. The method of claim 1, further comprising:
receiving, by the controller, a status of the EV battery.

5. The method of claim 1, further comprising:
controlling, by the controller, the EV battery.

6. The method of claim 1, wherein the transmitting, by the controller, the discrete signal to the EV battery comprises sending two or more discrete signals to the EV battery.

7. The method of claim 1, further comprising:
receiving, by the controller, data from the EV battery in response the transmitting the communications signal to the EV battery.

8. The method of claim 1, wherein the communications signal is a CAN bus signal.

9. The method of claim 1, wherein the providing the signal to the EV battery comprises sending power from an enabler battery electrical connected to the controller to the EV battery.

10. A battery enabler device for enabling an EV battery comprising:
a controller in electrical connection with the EV battery;
a discrete signal interface for sending a discrete signal to the EV battery:
a communication interface for sending a communication signal from the controller to the EV battery; and
a power interface electrically connected to the controller and configured to provide a power supply to the EV battery.

11. The battery enabler device of claim 10, wherein the communication interface is further configured to receive communication signals from the EV battery.

12. The battery enabler device of claim 10, wherein the controller is connected to a main power connector of the EV battery and configured to receive power from the EV battery from the main power connector.

13. The battery enabler device of claim 10, further comprising an enabler battery, the enabler battery is electrically connected to the controller and configured to provide power to the controller.

14. The battery enabler device of claim 12, wherein the controller is connected to the main power connector of the EV battery by a high voltage interface, wherein the high voltage interface converts the power from a high voltage to a lower voltage.

15. The battery enabler device of claim 10, wherein the controller is further configured to determine a power output of the EV battery.

16. The battery enabler device of claim 10, wherein the controller is further configured receive a status of the EV battery.

17. A method of enabling an EV battery comprising:
providing, by a controller, a power supply to the EV battery;
transmitting, by the controller, a first discrete signal and a second discrete signal to the EV battery;
receiving, by the controller, a signal from the EV battery in response to the providing the first discrete signal and the second discrete signal.

18. The method of claim 17, wherein the first discrete signal is configured to power a battery management of the EV battery and the second discrete signal is configured to power one or more contactors of the EV battery.

19. The method of claim 17, further comprising:
sending, by the controller, a communication signal to the EV battery.

20. The method of claim 19, further comprising:
receiving, by the controller, a power output from the EV battery in response to the communication signal.
